(19) United States
(12) Patent Application Publication
(10) Pub. No.: US 2011/0222095 A1
(43) Pub. Date: Sep. 15, 2011

(54) MULTIFUNCTION DEVICE FOR QUICK EXECUTION OF FUNCTIONS AND EXECUTION METHOD THEREOF

(76) Inventor: Thomas SHENG, Hsinchu (TW)

(21) Appl. No.: 13/043,153

(22) Filed: Mar. 8, 2011

(30) Foreign Application Priority Data
Mar. 10, 2010 (TW) 099106850

(51) Int. Cl. G06F 15/00

(52) U.S. Cl. 358/1.13

(57) ABSTRACT

A multifunction device for quick execution of functions thereof includes a processing module, and a scanning unit, a user interface and an output module, all of which are connected to the processing module. The scanning unit performs image acquisition on an original to generate a scan image signal representative of an image of the original. The user interface includes a display unit and an operation interface. The display unit displays a representation image of the scan image signal. The operation interface receives a user input. After the representation image is displayed, the processing module receives a user setting signal containing user input information from the operation interface and generates an output signal according to the user setting signal and the scan image signal. The output module outputs an output result corresponding to the output signal.

This application claims priority of No. 099106850 filed in Taiwan R.O.C. on Mar. 30, 2010 under 35 USC 119, the entire content of which is hereby incorporated by reference.

### BACKGROUND OF THE INVENTION

1. Field of the Invention

The present invention relates in general to a multifunction device and an execution method thereof, and more particularly to a multifunction device for quick execution of functions and an execution method thereof.

2. Related Art

Generally, copiers nowadays provide user-friendly operations and communication interfaces; however, these conventional copiers are basically passive devices and require users to manually input commands at each step of the operation in order to complete the copy process and produce the desired results. To execute the copy operation on the conventional copier, the user inputs or selects associated settings, and then presses the “START” button. Afterwards, the copier produces the duplicates of the originals and completes the copy process according to the user inputs.

In the conventional art, the copier waits for the user to give commands, and the user waits for the copier to perform the scanning and printing processes before either one can carry out the subsequent action, and consequently plenty of time is wasted. For example, when a user, who is not familiar with the operations of the copier, wants to copy a single page of a document, the user has to first place the page to be copied in the copy region, and then set the parameters for copy counts, scaling ratios, resolutions and etc, and finally press the “START” button to start the copy process. Sometimes, the user needs to try many different settings to obtain the desired result, which results in waste of time, toners and print paper.

### SUMMARY OF THE INVENTION

Accordingly, the present invention has been proposed to solve the problems of the prior art, and it is an object of the present invention to provide a multifunction device for quick execution of functions thereof and an execution method thereof. With a preview function and a bidirectional communication interface, the multifunction device can quickly execute its functions.

To achieve the above-identified object, the present invention provides a multifunction device including a processing module, a scanning unit, a user interface and an output module. The scanning unit, the user interface and the output module are electrically connected to the processing module. The scanning unit performs image acquisition on an original to generate a scan image signal representative of an image of the original. The user interface comprises a display unit for displaying a representation image of the scan image signal, and an operation interface for receiving a user input. After the representation image is displayed, the processing module receives a user setting signal containing user input information from the operation interface and generates an output signal according to the scan image signal and the user setting signal. The output module outputs an output result corresponding to the output signal.

The present invention also provides an execution method of a multifunction device. The method includes the steps of: performing image acquisition on an original to generate a scan image signal; displaying a representation image of the scan image signal; receiving a user setting input and generating an output signal according to the scan image signal and the user setting input; and generating an output result corresponding to the output signal.

By the multifunction device and its execution method of the present invention, the steps of the conventional operation sequence are minimized and simplified and they can be performed concurrently to shorten the overall time for processing the documents. Besides, the user receives the optimal output result without undergoing the trial-and-error process and without producing a lot of wastes. In addition, electric energy and toners are saved for environmental protection.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

FIG. 1 is a pictorial view showing a multifunction device according to the present invention.

FIGS. 2 and 3 are schematic illustrations showing the multifunction device according to a first embodiment of the present invention.

FIGS. 4 and 5 are schematic illustrations showing a multifunction device according to a second embodiment of the present invention.

FIG. 6 is a flow chart showing an execution method of the multifunction device according to the first embodiment of the present invention.

FIG. 7 is a flow chart showing an execution method of the multifunction device according to the second embodiment of the present invention.

### DETAILED DESCRIPTION OF THE INVENTION

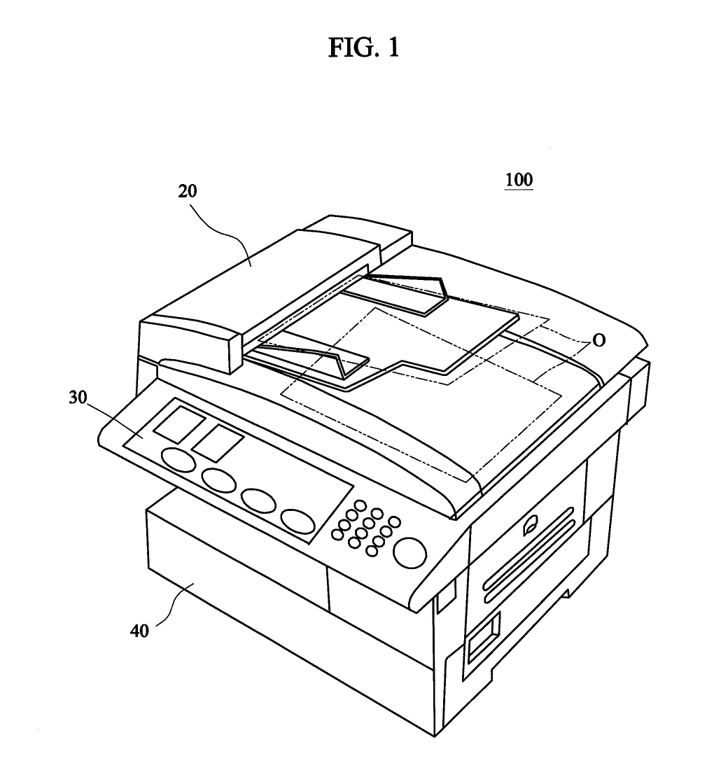

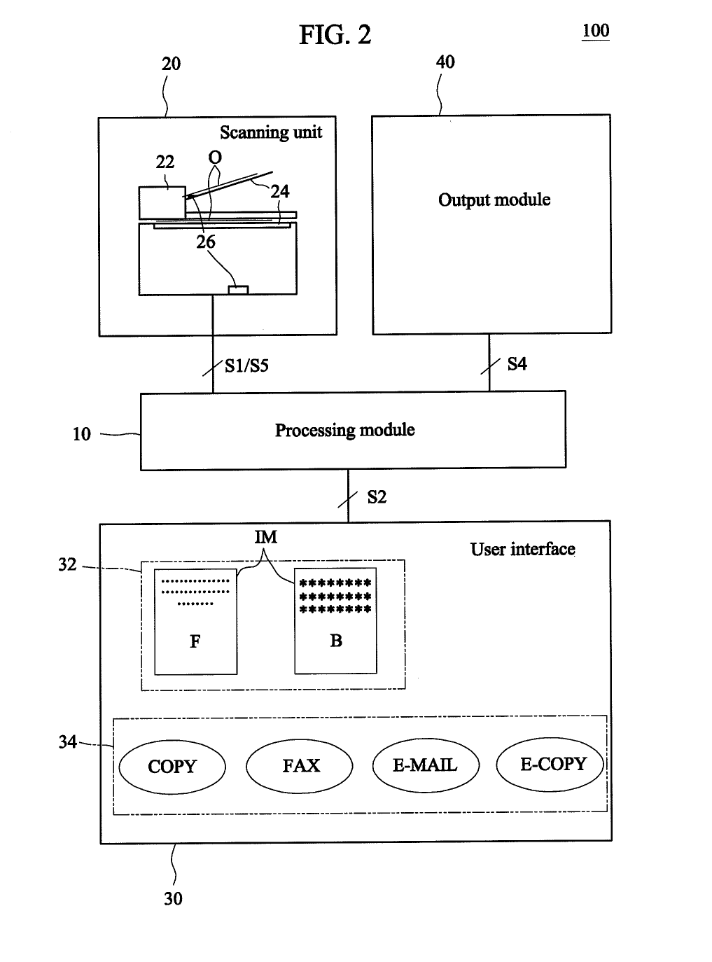

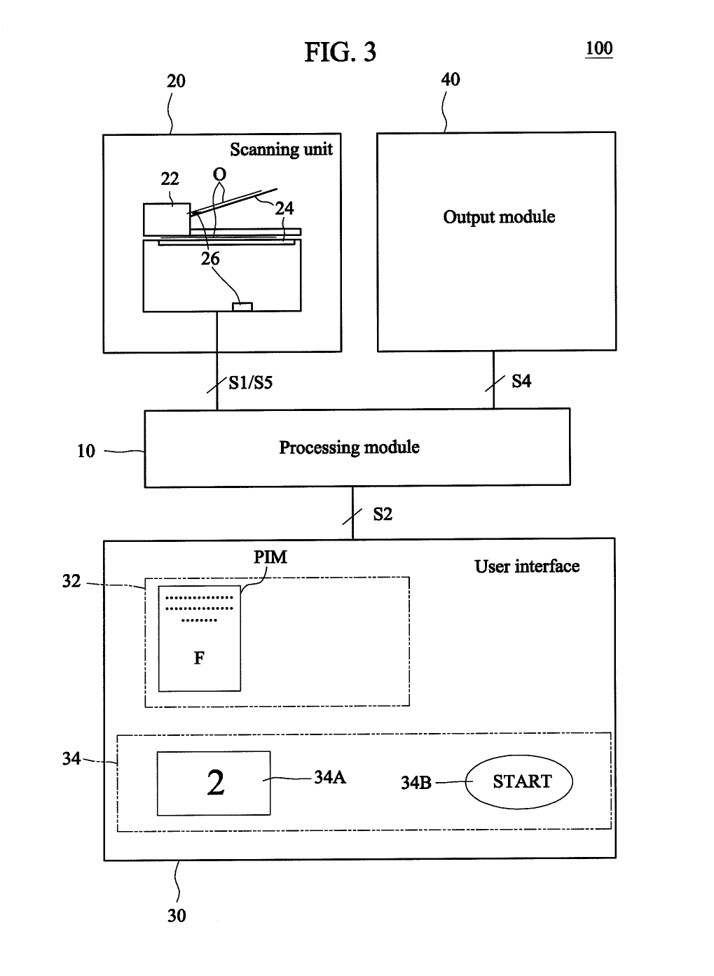

FIG. 1 is a pictorial view showing a multifunction device 100 according to the present invention. FIGS. 2 and 3 are schematic illustrations showing the multifunction device 100 according to a first embodiment of the present invention. Referring to FIGS. 1 to 3, the multifunction device 100, capable of paper-feed scan and flatbed scan, provides the functions of scan, print, copy, fax, e-mail, network-filing and electronic file-saving. In this embodiment, the multifunction device 100 includes a processing module 10, and a scanning unit 20, a user interface 30 and an output module 40, all of which are electrically connected to the processing module 10 and are disposed in the same casing.

The scanning unit 20 is used for acquiring an image of an original O to generate a scan image signal S1 representative of the image of the original O. The scan image signal S1 may include a front side image, a backside image or both of the front and back side images of the original O, or only the front (back) side images of a plurality of originals O. The scanning unit 20 could be a simplex document scanner or a duplex document scanner.

The user interface 30 includes a display unit 32 and an operation interface 34, which are composed of separate members, such as screens and buttons, or are integrated into a touch screen, for example.

The display unit 32 is used for displaying a representation image IM of the scan image signal S1. The operation interface 34 is used for receiving a user input for the operation of the multifunction device 100. A user enables a function or mode by clicking, pressing or sliding on the operation interface 34, or input parameter values for configuration settings, including image scaling ratio, brightness, color contrast, copy count, e-mail addresses, fax numbers, file formats, file-saving destinations, and etc. Alternatively, the operation interface 34 may comprise a voice recognition system detecting a sound or voice input from the user. The processing module 10 receives a user setting signal S2 containing user input information from the operation interface 34 and generates an output signal S4 according to the scan image signal S1 and the user setting signal S2.

In addition to inputting the user selection and parameter values through the user interface 30, the user also may load a personal preference configuration file to the multifunction device 100 from a flash disk connected to a connection port of the multifunction device 100.

The output module 40 includes at least one of a printing module, a fax module, a network connection interface and a device connection interface. The output module 40 outputs an output result corresponding to the output signal S4. Thus, the output result may include any one of a printout, a fax message, an e-mail message and an electric file.

The operation sequence for executing the image processing functions is described in the following. After the scanning unit 20 completes the image acquisition of the original O, the display unit 32 displays the representation image(s) IM of the original O and the function options, including the copy option (COPY), fax option (FAX), e-mail option (E-MAIL), file-saving option (E-COPY) and etc, as shown in FIG. 2, for user selection. If the scanning unit 20 double-sided scans the original O, the display unit 32 displays a first-side representation image and a second-side representation image of the original O. If only one page of image of the original O is to be outputted, the user can select, from the two displayed images, the one image to be outputted. The multifunction device 100 generates and outputs the output signal S4 according to the selection of a particular function. It is to be noted that the user can change the output mode whenever necessary during the process.

Take the copy function as an example. After the copy function is selected, the user interface 30 provides options for the detailed settings for the copy operation of the original O, or prompts the user to specify the detailed settings. For example, if the user interface 30 is a touch screen, the screen shows a copy count option 34A or configuration settings for adjustment of the representation image IM, such as its brightness, contrast and etc. When the processing module 10 receives these detailed settings, the display unit 32 immediately displays an adjusted, processed representation image PIM, as shown in FIG. 3. The user can continue to adjust the processed representation image PIM or select a start option (START) 34B to trigger the generation of the output signal S4 and enable the output sequence through the output module 40 for generating a duplicate document of the original O.

In detail, in response to the selection of the start option 34B, the processing module 10 generates the output signal S4 according to the scan image signal S1 and the user setting signal S2. In this case, the output signal S4 includes a print job. The output signal S4 is transmitted to the printing module 40 and the printing module 40 prints the image(s) of the output signal S4 on recording media, for example, blank sheets of paper.

In this embodiment, as shown in FIGS. 2 and 3, the multifunction device 100 further includes a platen 24 and a sheet detecting module 26, which generates a ready signal S5 upon detection of the original O placed on the platen 24. If the scanning unit 20 is configured for flatbed scan, the sheet detecting module 26 detects the presence of the original O on a scan window 24 on a flatbed. If the scanning unit 20 is configured for paper-feed scan, the sheet detecting module 26 detects the presence of the original O on a sheet-supply tray 24 or at a document feeding entry of an automatic document feeder 22. The processing module 10 initiates the image acquisition sequence upon receiving the ready signal S5. The processing module 10 at first controls the document feeder 22 to feed in the original O on the sheet-supply tray 24, and when the original is transported to the scan region, the scanning unit 20 starts to acquire the images of the original O and completes the scan as the original O past the scan region. One of the advantages of this present invention is that during the image acquisition process users need not to operate the multifunction device 100, either to initiate the process or to adjust the scan parameters.

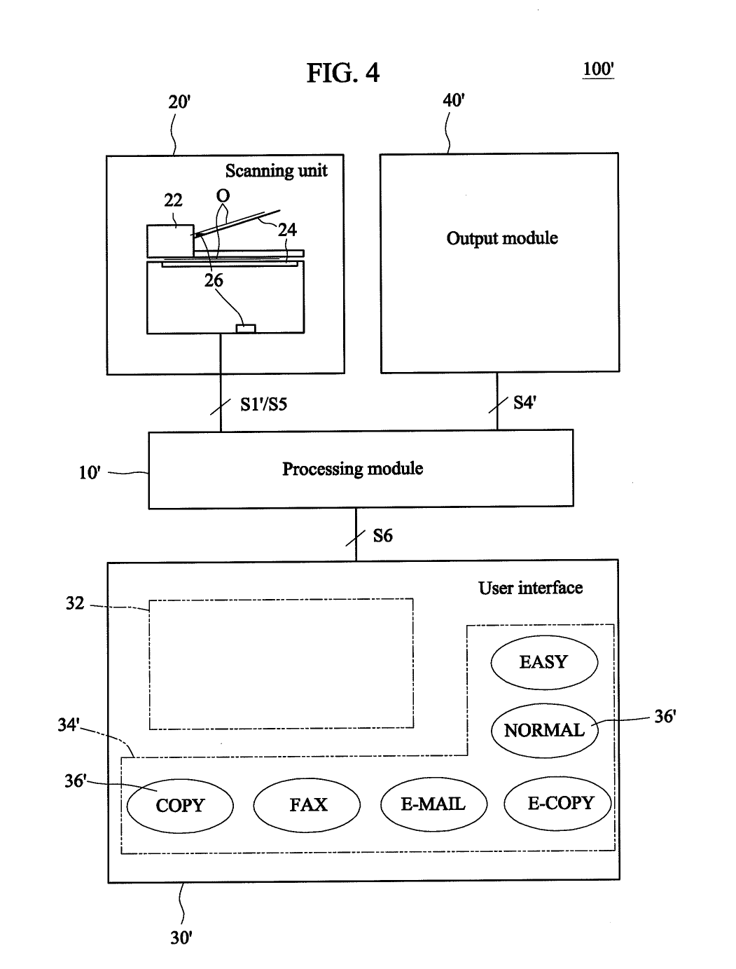

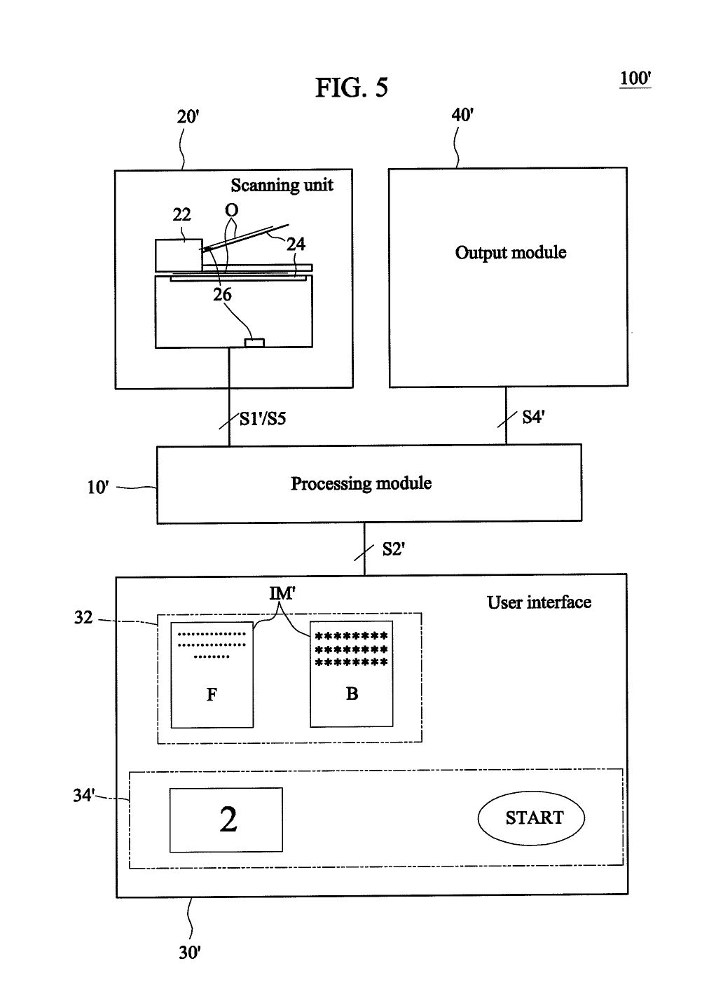

FIGS. 4 and 5 are schematic illustrations showing a multifunction device 100′ according to a second embodiment of the present invention. As shown in FIG. 4, the user interface 30′ provides a plurality of function/mode options 36′. In response to selection of one of the functions or modes, the operation interface 34′ transmits a selection signal S6 to the processing module 10′. In this embodiment, the function options 36′ include at least two of the copy function, fax function, e-mail function and file-saving function; and the mode options 36′ include an easy mode (EASY MODE) and a normal mode (NORMAL MODE).

The processing module 10′ initiates the image acquisition of the original O when receiving the selection signal S6. After the image acquisition is completed, the scanning unit 20′ generates a scan image signal St. As shown in FIG. 5, subsequent to the selection of the copy function, the scanning unit 20′ starts the image acquisition, and after the completion of the image acquisition, the user interface 30′ displays the representation image IM′ of the scan image signal St and provides only the copy-associated setting options for the user to input instructions. After the user finishes the adjustment of the function and image settings, the user interface 30′ generates and transmits the user setting signal S2′ to the processing module 10′. Finally, the processing module 10′ generates the output signal S4′ (print job) according to the scan image signal S1', the user setting signal S2′ and the selection signal S6, and transmits the output signal S4′ to the printing module 40′, which prints the images contained in the output signal S4′ on the recording media. Since this can be easily understood, detailed descriptions thereof are omitted.

Alternatively, the user can select from one of the mode options. If the normal mode is selected, the multifunction device 100′ operates using conventional execution methods, in which the multifunction device 100′ may provide a complete set of options for adjustment of shading, brightness, synthesis processing, and etc. If the easy mode is selected, the multifunction device 100′ performs a high-efficiency operation and generates the optimal output result with the least number of operation steps. In the easy mode, a function, for example, a 600 dpi-duplex-color copy function which has been pre-defined with specified scan setting parameters and image-processing routines, is executed. After the completion of the image acquisition, the user can adjust the output settings for the printout job, for example, the copy counts, odd or even-numbered-page-only print, double-sided print, 2-to-1 print, or for the selection of the recording media, or simply press the “OK” key, and the multifunction device 100′ will output the resulting work accordingly. The predefined image-processing routines include automatic deskew, automatic frame cropping, automatic background removal, alignment, automatic blank page detection, color attribute adjustment, automatic size detection, and etc.

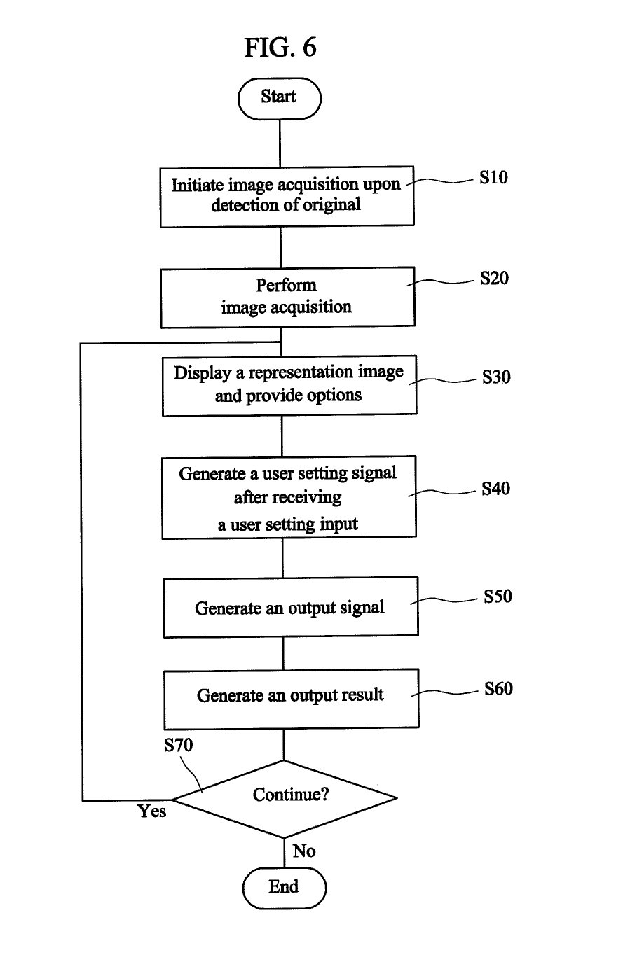

FIG. 6 is a flow chart showing an execution method of the multifunction device 100 of FIG. 2. As shown in FIG. 6, the execution method includes, preferably in order, the following steps.

First, in step S10, the processing module 10 initiates the image acquisition upon detection of the original O. Specifically speaking, the sheet detecting module 26 generates the ready signal S5 if it senses the original O is placed on the platen 24 of the multifunction device 100; when receiving the ready signal S5, the processing module 10 initiates the image acquisition. It is to be noted that the image acquisition sequence may be initiated manually by the user.

In step S20, the scanning unit 20 performs the image acquisition on the original O and generates the scan image signal S1 at the completion of the image acquisition.

Then, in step S30, the user interface 30 displays the representation image IM of the scan image signal S1 and provides function and setting options. For example, after the copy function option is selected, the user interface 30 provides options for the detailed settings for the copy operation of the original O, or prompts the user to specify the parameter values for the settings for the function selected and the image displayed.

Next, in step S40, the user interface 30, after receiving the parameter values and instructions from the user, generates the user setting signal S2.

In step S50, the processing module 10 generates the output signal S4 according to the scan image signal S1 received from the scanning unit 20 and the user setting signal S2 received from the user interface 30. In addition, prior to the generation of the output signal S4, the processed representation image PIM, which has been processed according to the scan image signal S1 and the user setting signal S2, is displayed on the display unit 32 and available for any further image adjustment by the user.

Then, in step S60, the output module 40 generates the output result corresponding to the output signal S4.

Next, in step S70, the user is inquired by the multifunction device 100 whether or not to continue processing the scan image signal S1. The method returns to step S30 if the answer is positive; otherwise, the method ends. For example, after the copy operation is completed and a printout of the original O is obtained, an inquiry message will be displayed on the touch screen 30. The user may choose to request another output function implementing on the scan image of the original O, or end and proceed to another document. If the user chooses to continue with this scan image of the original O, the touch screen 30 will display the representation image IM and provide function and setting options.

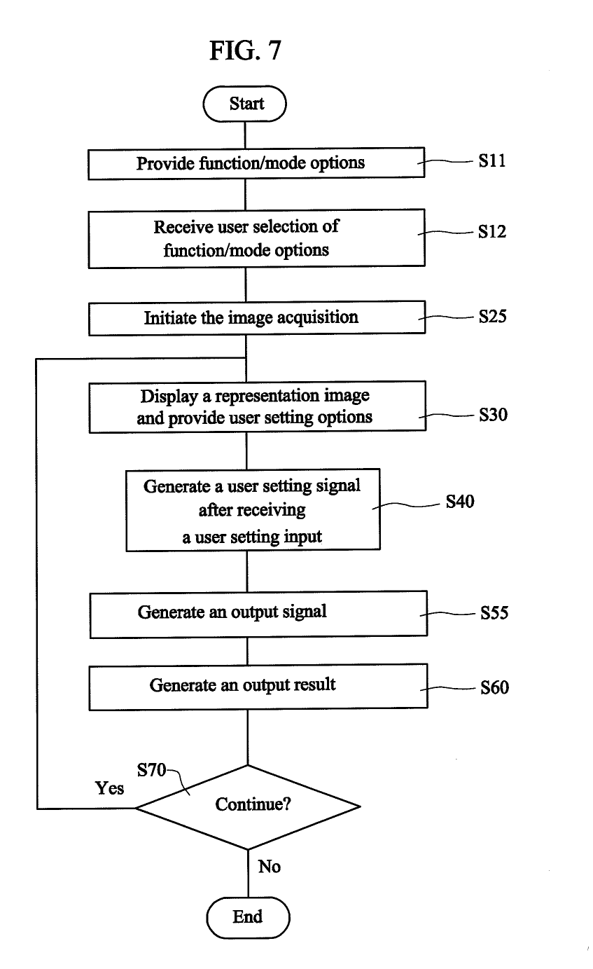

FIG. 7 is a flow chart showing an execution method of the multifunction device 100′ of FIG. 4. As shown in FIG. 7, the execution method is described as follows.

First, in step S11, a plurality of function/mode options is provided at the user interface 30′ of the multifunction device 100′.

Next, in step S12, the user interface 30′ receives the user selection of any one of the function/mode options and transmits the selection signal S6 to the processing module 10′ accordingly.

Then, in the step S25, the processing module 10′ initiates the image acquisition upon receiving the selection signal S6.

Next, in step S30, the user interface 30′ displays the representation image IM′ of the scan image signal St after the completion of the image acquisition by the scanning unit 20′ and provides the output setting options. For example, if the easy mode option is selected at step S12, the user interface 30′, beside displaying the representation image IM′, provides options for the output settings for the 600 dpi-duplex-color copy operation of the original O, or prompts the user to specify the parameter values for the output settings for the function selected and the image displayed.

Then, in step S40, the user interface 30′, after receiving the parameter values or instructions, from the user for the output settings, generates the user setting signal S2′.

In step S55, the processing module 10′ generates the output signal S4′ according to the scan image signal St, the selection signal S6 and the user setting signal S2′.

Next, in step S60, the output module 40′ generates the output result corresponding to the output signal S4′.

Then, in step S70, the user is inquired by the multifunction device 100′ whether or not to continue processing the scan image signal St. The method returns to step S30 if the answer is positive; otherwise, the method ends. For example, after the 600 dpi-duplex-color copy operation is completed and a color printout of the original O is obtained, an inquiry message will be displayed on the touch screen 30′. The user may choose to request the same output function, but with different output settings, implementing on the scan image of the original O, or end and proceed to another document or another output function. If the user chooses to continue to make a 600 dpi-duplex-color copy of this scan image of the original O, the touch screen 30′ will display the representation image IM′ and provide the associated output setting options.

By the multifunction device and its execution method of the present invention, the conventional user operation may be simplified, or the steps of the operation may be performed concurrently to shorten the time of processing a batch of documents. In addition, the user may review the scan image on the display screen beforehand and obtain the desired result. In this manner, it is possible to prevent the consumable material from being wasted when the user is performing the copying operation.

While the present invention has been described by way of examples and in terms of preferred embodiments, it is to be understood that the present invention is not limited thereto. To the contrary, it is intended to cover various modifications. Therefore, the scope of the appended claims should be accorded the broadest interpretation so as to encompass all such modifications.

What is claimed is:

1. A multifunction device, comprising:
a processing module; and
a scanning unit, a user interface and an output module, all of which are electrically connected to the processing module, wherein,
the scanning unit performs image acquisition on an original to generate a scan image signal representative of an image of the original;
the user interface comprises a display unit for displaying a representation image of the scan image signal, and an operation interface for receiving a user input;
after the representation image is displayed, the processing module receives a user setting signal containing user input information from the operation interface and generates an output signal according to the scan image signal and the user setting signal; and
the output module outputs an output result corresponding to the output signal.

2. The multifunction device according to claim 1, wherein the user interface comprises a touch screen.

3. The multifunction device according to claim 1, wherein the output result comprises one of a printout, a fax message, an e-mail and an electric file.

4. The multifunction device according to claim 1, wherein the display unit further displays a processed representation image before the output module outputs the output result corresponding to the output signal.

5. The multifunction device according to claim 1, further comprising a platen, and a sheet detecting module for generating a ready signal upon detection of the original placed on the platen.

6. The multifunction device according to claim 5, wherein the processing module initiates the image acquisition in response to the ready signal.

7. The multifunction device according to claim 1, wherein the scan image signal comprises a first-side image signal and a second-side image signal, the display unit displays a first representation image of the first-side image signal and a second representation image of the second-side image signal for user selection via the operation interface.

8. The multifunction device according to claim 1, wherein the user interface further provides a plurality of function/mode options, the operation interface transmits to the processing module a selection signal representing one of function/mode options being selected, the processing module initiates the image acquisition upon receiving the selection signal, and the processing module generates the output signal according to the scan image signal, the selection signal and the user setting signal.

9. The multifunction device according to claim 8, wherein the function/mode options comprise at least two of a copy option, a fax option, an e-mail option and a file-saving option.

10. The multifunction device according to claim 8, wherein the function/mode options comprise an easy mode option and a normal mode option.

11. An execution method of a multifunction device, comprising the steps of:
(a) performing image acquisition on an original to generate a scan image signal;
(b) displaying a representation image of the scan image signal;
(c) receiving a user setting input and generating an output signal according to the scan image signal and the user setting input; and
(d) generating an output result corresponding to the output signal.

12. The method according to claim 11, further comprising, before the step (a), the steps of:
(a1) detecting presence of the original placed on a platen of the multifunction device; and
(a2) initiating the image acquisition upon detection of the original.

13. The method according to claim 11, further comprising, before the step (a), the steps of:
(a3) providing a plurality of function/mode options;
(a4) receiving a user selection input selecting one of the function/mode options; and
(a5) initiating the image acquisition in response to the user selection input.

14. The method according to claim 13, wherein the step (c) comprises:
generating the output signal according to the scan image signal, the user selection input and the user setting input.

15. The method according to claim 11, wherein after the step (c) the method further comprises:
generating a processed image signal according to the scan image signal and the user setting input; and
displaying a processed representation image of the processed image signal.

16. The method according to claim 11, further comprising, after the step (d), the step of:
returning to the step (b).
